(19) United States
(12) Patent Application Publication
(10) Pub. No.: US 2016/0077571 A1
(43) Pub. Date: Mar. 17, 2016

(54) Heuristic Processor Power Management in Operating Systems

(71) Applicant: Microsoft Corporation, Redmond, WA (US)

(72) Inventors: Abhishek Sagar, Seattle, WA (US); Qi Zhang, Redmond, WA (US)

(21) Appl. No.: 14/484,758

(22) Filed: Sep. 12, 2014

(51) Int. Cl. G06F 1/32; G06F 11/34; G06F 11/30

(52) U.S. Cl. CPC G06F 1/3206; G06F 11/3024; G06F 11/3409

(57) ABSTRACT

Various embodiments provide techniques and devices for heuristics-based processor power management of the processor of a computing device. Processor performance metrics and workload are monitored. Processor management profiles are generated, stored, and adjusted using heuristic performance data. Appropriate power management profiles are applied to the processor to balance processor power consumption against performance expectations and enhance efficiency of processor operation.

### BACKGROUND

Management of power consumption in a computing device is important to extend the operational ability of a battery and to reduce overall power consumption, which can increase user safety and be both fiscally and environmentally beneficial, for example by reducing the thermal footprint of a device. Even for non-mobile computers, reducing power requirements is beneficial to save important global resources and prolong operation when relying on a battery backup system, such as during a utility power interruption. However, the desirability of reducing power consumption must be weighed against performance demands of the device based on user expectations and the device's workload and functions.

Processors traditionally use a substantial portion of the power in a computing device. Many modern processors also allow for programmatic control of power consumption at the kernel, operating system, and/or application level. Some processors can be switched between various processor modes representing, for example, 50%, 70%, or 90% of processing capability. At lower processing capability modes, both performance (e.g. processor calculation speed) and power consumption are reduced.

By manipulating processor modes in a system based on, for example, workload of a device, user performance expectations, and monitored processor performance data, overall power consumption of a device can be reduced while maintaining acceptable performance criteria. Manipulating processor modes can include, for example, adjusting processor performance or power usage parameters, controlling the number of processor cores available to schedule threads in a device, or putting some processors or processor cores into a “sleep” mode to conserve power or lower device temperature. In addition, in systems utilizing multiple processors and/or virtual machines, each processor can be configured differently to enhance efficiency.

Some existing strategies for enhancing efficiency of processor power consumption focus on detecting the utilization of the central processing unit (CPU) to predict future needs or detecting in a broad sense the workload of particular tasks or threads being performed by the system and using apriori or presupposed metrics for associating performance requirements with workload of the device. Some of the existing strategies may not be optimal because of one or more of the following limitations: (1) difficulty of scalability when associating performance requirements exclusively or primarily with specific workloads, because new types of workloads that share characteristics with existing workloads may not be able to benefit from existing performance or power tuning because they are not the same type classification as similar existing workloads; (2) performance requirements are coarsely determined based on an entire workload or task type, instead of key periods of high performance within a workload; (3) workload-specific tuning does not take into account varying user performance expectations, for example a user's expectation that specific applications or hardware configurations should perform better or worse than others; (4) existing workload-specific tuning systems may not translate between real hardware systems and virtual environments; and (5) existing approaches do not adequately discriminate between overlapping workloads to determine the individual characteristics of each workload, or the existing approaches impose a significant performance cost to perform such an analysis.

### SUMMARY

This summary is provided to introduce concepts and techniques of heuristics-based processor power management of a computing device, which is further described below in the Detailed Description. For purposes of this disclosure, the term “processor” can refer to any hardware or virtual implementation thereof suitable for performing logical or arithmetic functions in a computing device or system. For example, “processor” may refer to a hardware or virtual implementation of a central processing unit, supplemental processor or coprocessor, microprocessor, graphics processing unit, memory management unit, mathematics coprocessor, or signal processor, among others. The techniques and devices discussed herein enable monitoring of processor usage metrics and balancing performance and power consumption based on performance expectations and the workload of a device. The processor power management techniques can use heuristics in the form of observed resource usage within a device to adjust or derive processor management profiles and performance requirements.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic (e.g., Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs)), and/or technique(s) as permitted by the context above and throughout the document.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 is a block diagram of an illustrative computing architecture 100 to provide heuristics-based processor power management of a computing device.

FIG. 2 is a flow chart of an example algorithm for adjusting CPU power management parameters according to some embodiments.

FIG. 3 is an example table of monitored processor performance metrics according to some embodiments.

FIG. 4 is a flow chart of an example algorithm for updating stored CPU power management profiles in response to monitored processor performance metrics and monitored user performance expectations, according to some embodiments.

FIG. 5 is a block diagram of an illustrative system incorporating multiple virtual machines associated with a single computing device.

FIG. 6 is a flow chart of an example algorithm for adjusting hardware CPU management parameters in response to data sampled from one or more virtual machines associated with the hardware CPU, according to some embodiments.

### DETAILED DESCRIPTION

### Overview

Various computing hardware, in particular computing device processors, are capable of operating in reduced power states (modes or p-states). For example, more complex devices, such as processors, may include various power states such as a low power state, an idle state, and so forth, which allow varying degrees of low power operation. Some processors can enable selectable modes of operation at further granularity representing, for example, 50%, 70%, or 90% or any other denomination of processing capability. At lower processing capability modes, both performance (e.g. processor calculation speed) and power consumption can be reduced.

To increase efficiency of the processor and conserve power, an operating system can monitor one or many processor usage metrics to estimate and/or record processor performance and processor performance requirements of executing particular threads or tasks. In a virtualized environment, these metrics can be gathered from actual hardware, gathered from each virtual machine and aggregated (for example, by PPM 120) to provide information pertinent to physical hardware, or both.

A power management module of a computing device determines an applicable processor management profile to be applied to a processor. A processor management profile can, for example, include adjustments to processor control parameters such as power usage and processor utilization, or adjusting the number of cores available for processing, including by setting one or more processors or cores to an inactive or “sleep” mode. The power management module can balancing data including changes in processor performance or requirements versus user or system performance expectations to choose an appropriate power management profile. For example, the power management module can be configured to choose the power management profile that will meet performance expectations using the least power compared to all other available power management profiles for the expected near-term processing requirements.

Heuristic or observed data, for example related to processor usage metrics and changes therein under similar processing requirements, and previous user performance expectations, can be used to modify or update stored power management profiles and/or can be used directly by the power management module to choose a processor management profile.

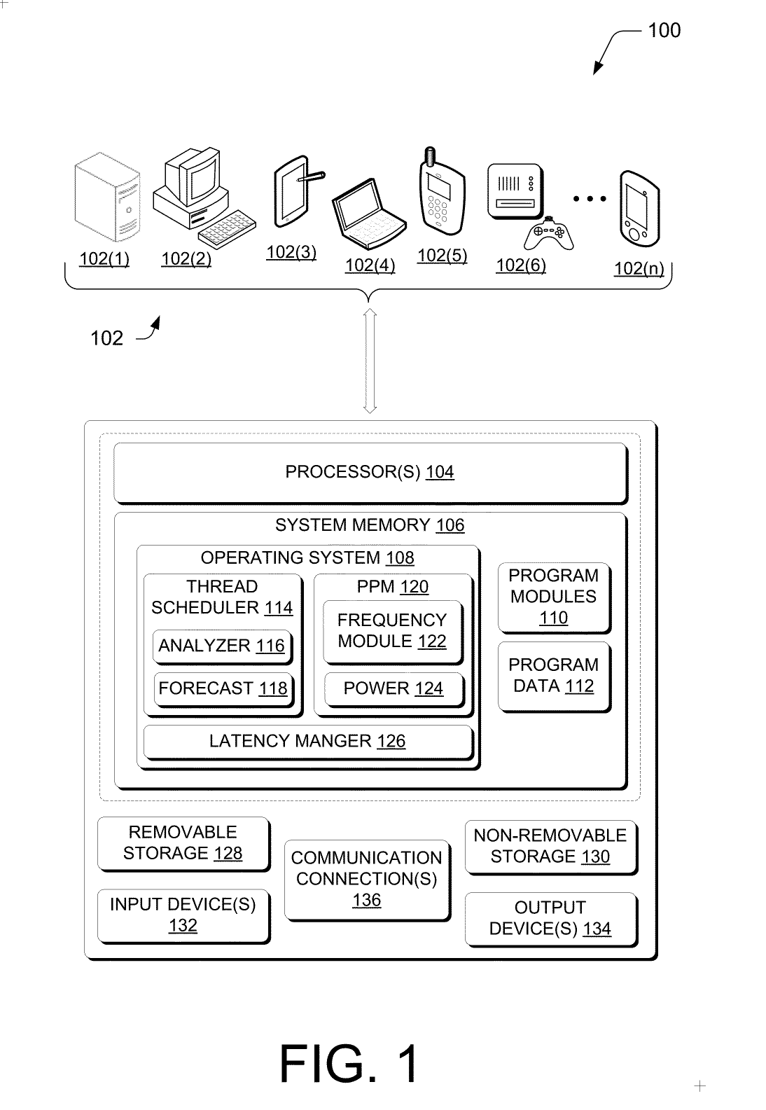

The processes and systems described herein can be implemented in a number of ways. Example implementations are provided below with reference to FIGS. 1-4.

### Illustrative Environment

FIG. 1 is a block diagram of an illustrative computing architecture 100 to provide heuristics-based processor power management of a computing device. The architecture 100 includes a computing device 102. For example, the computing device can be a server 102(1), a desktop computer 102(2), a tablet 102(3), a mobile computer 102(4), a mobile telephone 102(5), a gaming console, and a music player 102(n), among other possible computing devices. As discussed herein, any reference of the computing device 102 is to be interpreted to include any of the computing devices 102(1)-(n).

In a very basic configuration, computing device 102 may typically include one or more processors (“processors”) 104. For example, the processors 104 can be at least one of multiple independent processors configured in parallel or in series in a multi-core processing unit, either singly or in various combinations. A processor might have two or more processors (“cores”) included on the same chip or integrated circuit. The terms “processor,” “core,” and “logical processor” can be used interchangeably throughout this disclosure unless specifically stated otherwise with reference to a particular element.

In addition, the computing device 102 may include system memory 106. Depending on the exact configuration and type of computing device, system memory 106 can be volatile (such as RAM), non-volatile (such as ROM, flash memory, etc.) or some combination of the two. System memory 106 may include an operating system 108, one or more program modules 110, and may include program data 112.

In accordance with one or more embodiments, the operating system 108 may include a thread scheduler 114 to enable queuing, scheduling, prioritizing, and dispatching units of work (threads), among other possible schedule-related activities, across all available processors 104 or other hardware (e.g., monitors, memory, disk drives, peripheral devices, and so forth) in the architecture 100. For example, when an active thread is ready to be run, the thread scheduler 114, via one or more modules, may dispatch the thread to any available one of the processors 104 for processing.

In accordance with some embodiments, the thread scheduler 114 may include an analyzer module 116 that monitors computing activities (user generated activities, hardware operation, application state, etc.). The analyzed scheduler can be used by a forecast module 118 to forecast a workload of the computing device 102. The forecast may include low volume segments where a power reduction can be foreseeably achieved by reducing the power state of the processor(s) 104 and/or other hardware of the computing device 102 or in connection to the computing device.

The operating system 108 may include a processor power manager (“PPM”) 120 to adjust the performance of the processors 104 and/or hardware when, for example, a reduced power need or increase in performance is anticipated by the forecast module 118. A frequency module 122 may enable adjustment of the speed of the processors 104 and/or hardware (via frequency and voltage) such as by controlling a P-state (frequency/voltage controller) of the processors 104. In addition, the processor power manager 120 may include a power module 124 that may reduce the power (performance) state of the processors 104 and/or hardware to low power (performance) states, such as by controlling a C-state of the processors.

The thread scheduler 114 and the processor power manager 120 may work collectively to reduce power consumption of the computing device 102 by forecasting performance-requirements and then directing hardware to reduce or increase power states (via the frequency module 122 and/or the power module 124) when a cost-benefit analysis indicates a net power reduction associated with the reduced power state.

In some embodiments, the operating system 108 may include a latency manager 126 to evaluate user-perceived latency associated with the hardware of the computing devices 102 and/or the performance of the program modules 110 as a result of the processors 104. For example, the latency manager 126 compare the user-perceived latency to a latency threshold as part of controlling the power requirements, (via the processor power manager 120) when user-perceived latency meets (or exceeds) the latency threshold. In other embodiments, a performance expectation rating or tier can be associated with a device, a hardware configuration, or various activities, for example threads, applications, and device functions.

The computing device 102 may have additional features or functionality. For example, the computing device 102 may also include additional data storage devices (removable and/or non-removable) such as, for example, magnetic disks, optical disks, tape, or a connection to remote or “cloud” storage. Such additional storage is illustrated in FIG. 1 by a removable storage 128 and a non-removable storage 130. The computer storage media may include volatile and nonvolatile, removable and non-removable media implemented in any method or technology for storage of information, such as computer readable instructions, data structures, program modules, or other data. The system memory 106, the removable storage 128 and the non-removable storage 130 are all examples of the computer storage media. Thus, the computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 102. Any such computer storage media can be part of the computing device 102.

The computing device 102 may also have one or more input devices 132 such as a keyboard, a mouse, a pen, voice input device, a touch input device, etc. One or more output device 134 such as a display, speaker, printer, etc. may also be included either directly or via a connection to the computing device 102. The computing device 102 may also include a communication connection 136 that allows the device to communicate with other computing devices over e.g., a wired or wireless network.

### Illustrative Processes

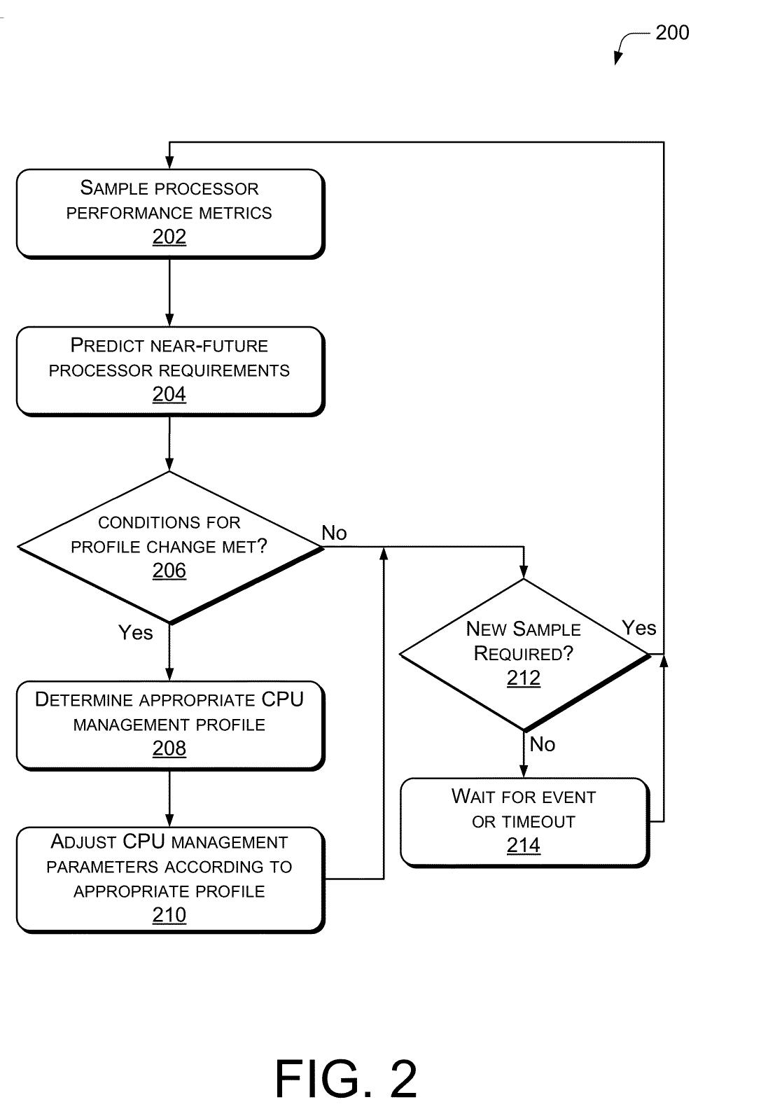

FIG. 2 is a flow chart of an example algorithm for adjusting CPU power management parameters according to some embodiments. In various embodiments, the processes of FIG. 2 can be performed substantially by PPM 120 or by any combination of thread scheduler 114, analyzer module 116, forecast module 118, PPM 120, latency manager 126, and other tangible or abstract software or hardware modules or devices.

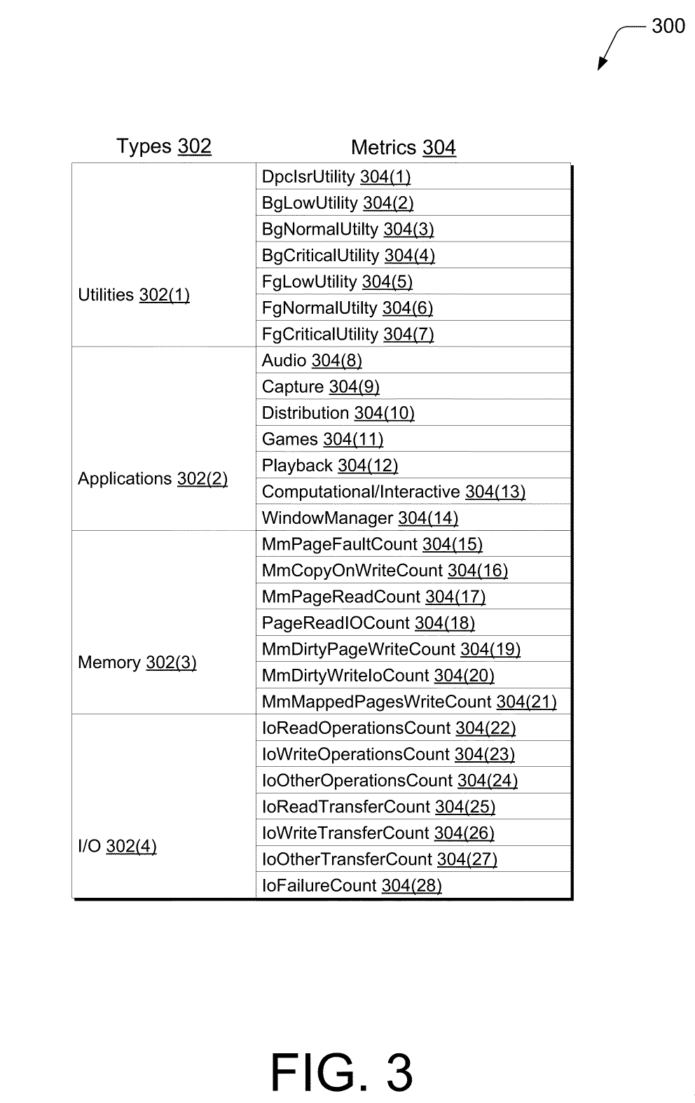

In some embodiments, sample processor performance metrics are monitored at step 202. Examples of monitored processor performance metrics include, but are not limited to, latency tolerance of running threads, thread priority, memory page-fault count or derived statistics, input/output operation counts, device interrupt counts, percentage of work done by various threads in a system, and thread execution time. Further detailed examples of monitored processor performance metrics are provided at FIG. 3 and discussed in the detailed description of FIG. 3 below.

In some embodiments, a latency manager 126 may evaluate user-perceived latency associated with the hardware of computing devices 102. Such evaluation may occur at any or all of many levels, for example evaluation of user-perceived latency of a particular hardware configuration in general or evaluation of user-perceived latency of any number of specific threads, thread or task types, native device and/or operating system functions or utilities, or software applications.

In some embodiments, a priority can be associated with various tasks performed by a device. For example, one or more priority can be assigned to specific kernel execution threads or parts thereof, particular activities or types of device activities, operating system functions or utilities, or software applications. A priority system can be, for example, a simple binary high- or low-priority rating. In other embodiments, a thread priority system may encompass any number of intermediate priority ratings.

In some embodiments, various thread or task types can be handled differently by PPM 120. For example, performance expectations of, for example, a user, organization, or system administrator can be associated with particular threads, task types, device functions, or applications. In some embodiments, a module such as latency manager 126 may passively or actively evaluate a user's perception of whether a device is performing well or not for particular activities or threads. In some embodiments, a performance expectation tier rating can be associated with particular threads, task types, applications, or device or peripheral functions including performance and power states. Such associations can be made explicitly by a user or by a system module in various embodiments. In some embodiments, functions such as power state and usage frequency of a peripheral (e.g. graphic processing unit, device camera, media codecs) can be used in calculating a performance expectation. In some implementations, a performance expectation for a processor can be derived in whole or part based on information related to other devices or processors. For example, frequency of operation of a user's tablet device can be used in calculating performance expectations for the CPU of the same user's smartphone device.

At step 204 of some embodiments, the system generates a prediction of near-future processor requirements. This prediction can be generated by, for example, PPM 120 or forecast module 118, based on, current or known future kernel threads and associated characteristics thereof; user device usage habit taking into account, for example: time of day and day of week, geographical location, or previous user behavior including applications and activities previously used simultaneously or in close time proximity with one another; or direct observation of current sample processor performance metrics including consideration of previously observed patterns in such metrics.

In some embodiments at step 206, PPM 120 compares sampled processor performance metrics against saved conditions for changing the processor management profile. Profile change conditions can be defined by a system designer or generated using observed system data. In some embodiments, profile change conditions can be adjusted using observed heuristic data. In some embodiments, a processor management profile can be expressed as two numbers, X/Y, where X represents a processor performance increase threshold and Y represents a processor performance decrease threshold. Each of X and Y can represent a percentage of processor utilization in a particular processor management profile—X the percentage of processor utilization that can trigger an increase in processor performance or p-state, and Y the percentage of processor utilization that can trigger a decrease in processor performance or p-state. For example, a processor management profile represented as 60/30 can tell an operating system that when a processor is at 60% utilization or higher, the p-state can be increased, and when processor utilization is at 30% or lower, the p-state can be decreased.

Other conditions for changing a processor performance profile in various implementations may include a change in thread execution phase or detection of an event associated with high or low processing requirements. For example, a web browser application on a mobile device might execute passively, gathering and updating data on the device even when the device's screen is in idle mode. When a user of the device “wakes up” the phone to view the web browser data display, this event may trigger a change in performance profile even though the executing applications on the device have not changed. The extra power and processing performance required to actively display and refresh the screen necessitates additional performance. Additionally or alternatively, heuristic data about performance requirements of particular phases of a specific thread or type of thread can be used to revise existing processor power management profile change conditions or create new conditions.

At step 208 in some embodiments, having determined that a condition for profile change has been met, PPM 120 selects an appropriate management profile using the stored profile change conditions and sampled processor performance metrics. Where more than one profile change condition is set in some embodiments, profile change conditions can be ranked by priority. In other embodiments, PPM 120 can be configured such that various combinations of one or more profile change conditions can trigger a different processor management profile than would either of those conditions alone.

At step 210, PPM 120 applies the selected CPU management profile. The selected CPU management profile can define controls of a device's processor or processors. Additionally or alternatively in some implementations, a CPU management profile can define or adjust how sampled performance metrics or other system information is used or interpreted by PPM 120 or other parts of the computing device system. In some embodiments, changing the CPU management profile can be accomplished by accessing, for example, an Advanced Configuration and Power Interface (ACPI) of an operating system or by any other means of processor control provided by a processor manufacturer or a particular operating system of a device.

In an example embodiment, suppose a device is operating under a processor management profile of 90/80 and the system has a single stored profile change condition specifying that if a processor performance metric MmPageFaultCount is greater than 20, the processor management profile should be changed to 60/30. In such a sample embodiment at the step represented as 206 in FIG. 2, PPM 120 or another module of the device's operating system would compare the most recent value of MmPageFaultCount. If MmPageFaultCount is higher than 20 during the comparison of step 206, PPM 120 registers that a profile change condition has been met. Because there is only one profile management condition in this example embodiment, there are no condition conflicts to be resolved and the PPM 120 moves on to step 208 to determine the appropriate processor management profile. PPM 120 identifies the processor management profile (60/30) associated with the condition MmPageFaultCount >20. At step 210, PPM 120 implements the chosen processor management profile by accessing an ACPI or other interface to instruct the processor to change its performance parameters. In our example, if the “60/30” processor management profile indicates different processor performance parameters than those currently implemented in the processor, PPM 120 accesses an ACPI of the device's operating system to adjust processor parameters to conform with the “60/30” processor management profile.

At step 212, the system determines whether a new sample is required—for example because enough time has elapsed since the last sample of processor performance metrics or the system has received an event requiring an update or reassessment of performance expectations and response. In some implementations, a performance assessment can be triggered, for example, by a user waking up a device via tactile or speech input, launch or exiting of an application, or completion or suspension of a thread. If it is time for a new sample, algorithm execution returns to step 202. If a new sample is not yet required, the system waits at step 214 until a triggering event or the appropriate time for the next sample of processor performance metrics. Time between samples in the absence of another triggering event can be, for example, in the range of tens of milliseconds. In some embodiments, sample time is closely tuned to the particular hardware configuration(s) of a device and the physical and computing capabilities thereof. In some embodiments, sample timing can be adjusted by the system, for example, to sample more frequently during times of high processor activity or frequent thread switching, or sampling less frequently, for example, when a device is substantially in an “idle” state. If it is not time for a new sample, the system waits at step 214. In some example embodiments, sample times can typically be in the range of tens of milliseconds.

FIG. 3 is an example table of monitored processor performance metrics according to some embodiments. Categories or types 302 of processor performance metrics are provided in the left column for ease of human understanding. Such categories do not exist at all, or are not used by operating systems functions in some embodiments. Specific processor performance metrics 304 appear in the right column. Any, all, or none of the listed performance metrics can be used or available in any specific example system. These example metrics are not intended to be an exhaustive list. In various embodiments, these metrics can be accessed through an Advanced Configuration and Power Interface (ACPI) of an operating system.

The specific example metrics represented in FIG. 3 and categorized as utility type 302(1) are: deferred procedure call interrupt service utility DpcIsrUtility 304(1) (utility can be a measure of work done by a processor; in some embodiments expressed as average utilization frequency during an evaluation interval x busy-time, where busy-time can be derived, for example, from counting instruction cycles or non-idle time of a processor); background low utility BgLowUtility 304(2); background normal utility BgNormalUtilty 304(3); background critical utility BgCriticalUtility 304(4); foreground low utility FgLowUtility 304(5); foreground normal utility FgNormalUtilty 304(6); and foreground critical utility FgCriticalUtility 304(7).

Example metrics of FIG. 3 categorized as applications types Applications 302(2) are: audio applications Audio 304(8); capture applications Capture 304(9); distribution applications Distribution 304(10); game applications Games 304(11); playback applications Playback 304(12); computational and interactive applications Computational/Interactive 304(13); and window managing applications WindowManager 304(14).

Example metrics of FIG. 3 categorized as memory type 302(3) are: number of memory page faults MmPageFaultCount 304(15); number of memory copy-on-write functions MmCopyOnWriteCount 304(16); number of page read functions MmPageReadCount 304(17); number of page read inputs and outputs PageReadIOCount 304(18); number of dirty page writes MmDirtyPageWriteCount 304(19); number of dirty input/output writes MmDirtyWriteIoCount 304(20); and number of mapped page write functions MmMappedPagesWriteCount 304(21).

Example metrics of FIG. 3 categorized as input/output (“I/O”) type 302(4) are: number of read operations IoReadOperationsCount 304(22); number of write operations IoWriteOperationsCount 304(23); number of other I/O operations IoOtherOperationsCount 304(24); number of read transfers IoReadTransferCount 304(25); number of write transfers IoWriteTransferCount 304(26); number of other I/O transfers IoOtherTransferCount 304(27); and number of I/O failures IoFailureCount 304(28).

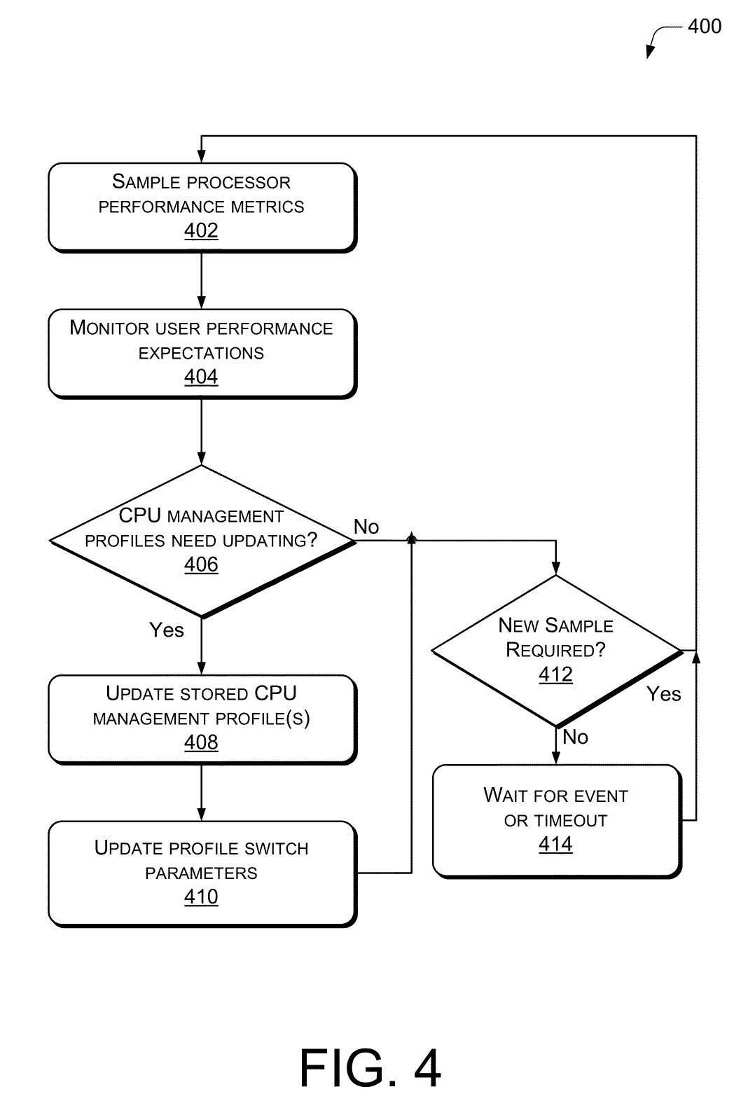

FIG. 4 is a flow chart of an example algorithm for updating stored CPU power management profiles in response to monitored processor performance parameters and monitored user performance expectations, according to some embodiments. In various embodiments, the processes of FIG. 4 can be performed substantially by PPM 120 or by any combination of thread scheduler 114, analyzer module 116, forecast module 118, PPM 120, latency manager 126, and other tangible or abstract software or hardware modules or devices.

In some embodiments, processor metrics can be sampled at step 402. In some embodiments, all or substantially all of the monitored processor performance metrics are the same as those monitored at step 202. In some embodiments, a separate sampling is not required at step 402, as the values sampled at step 202 of the CPU management parameter adjustment algorithm can also be used for the algorithm of FIG. 4 to update stored CPU power management profiles. In other embodiments, different or additional processor metrics can be monitored at step 402 and/or a separate polling of processor performance metrics can be performed at step 402.

At step 404 in some embodiments, user performance expectations are monitored. Latency manager 126, PPM 120, or any combination of other modules may monitor user performance expectations or service-level agreements. For example, user performance expectations in some embodiments can vary by specific application, time of day, activity or program type, or any number of other parameters. Additionally in some embodiments, latency manager 126 can apply user behavior analysis to detect user frustration or satisfaction with device performance. As an example, latency manager 126 in some embodiments may interpret repeated or duplicate control inputs or particular types of audible expressions by a user to indicate user frustration or perceived low performance.

In some embodiments, a performance expectation tier rating can be associated with particular threads, task types, device functions, or applications. This association can be made explicitly by a user in some embodiments, or calculated or interpolated by a system module in various embodiments. In some embodiments, latency manager 126 can calculate predictions about the future latency tolerances of users, for example based on heuristic data or the predefined rules discussed above.

At step 406 in various embodiments, PPM 120 determines whether CPU management profiles require updating. For example, in some embodiments a detected deficiency in performance can trigger a need to change one or more saved processor management profiles. Such a detected deficiency in performance can be, for example, a failure to execute particular tasks in a specified amount of time as defined by a user expectation tier. In other embodiments, reaching a threshold of user frustration detected by latency manager 126 can trigger a need to change one or more saved processor management profiles. In various embodiments, persistent over-performance in comparison to user expectations can also trigger a change stored processor management profiles, specifically to decrease performance to save power.

Other conditions for updating CPU management profiles in various implementations may be associated with various execution phases of specific threads or applications, including, for example, where high processing requirements exist for only a portion of an application's execution time. For example, a web browser application on a mobile device might execute passively, gathering and updating data on the device even when the device's screen is in idle mode. When a user of the device “wakes up” the phone to view the web browser data display, this event may trigger a change in performance profile even though the executing applications on the device have not changed. The extra power and processing performance required to actively display and refresh the screen necessitates additional performance. Additionally or alternatively, heuristic data about performance requirements of particular phases of a specific thread or type of thread can be used to revise existing CPU management profiles or create new profiles.

At step 408 if a CPU management profile requires updating, the system of various embodiments changes saved profile parameters to account for under- or over-performance. Using a previously discussed example rule (if MmPageFaultCount >20, change processor management profile to 60/30) if PPM 120 detected at step 406 that device performance is lower than user expectations when applying that rule, PPM 120 can update the processor management profile associated with MmPageFaultCount >20 to both increase and decrease processor performance at a lower threshold. For example, PPM 120 might change the associated 60/30 profile instead to 50/20. In some embodiments, other ACPI controls not specifically mentioned here or p-states can be associated with a condition or changed in response to user expectations.

In some embodiments at step 410, PPM 120 updates or adds profile switch parameters, if necessary, based on its comparison of user expectations versus performance as described herein. For example, PPM 120 might add to the system a rule that negates the example rule (if MmPageFaultCount >20, change processor management profile to 60/30) under certain circumstances—for example, if a video playback thread is running on the device.

At step 412 in some embodiments, the system determines whether a new sample is required—for example because enough time has elapsed since the last sample of processor performance metrics or the system has received an event requiring an update or reassessment of performance expectations. In some embodiments, steps 412 and 414 can be identical to steps 212 and 214 as described above. In other embodiments, separate (longer or shorter) sample times can be defined for purposes of updating stored CPU management profiles. If it is not time for a new sample, the system waits at step 214. In some example embodiments, sample times can typically be in the range of tens of milliseconds.

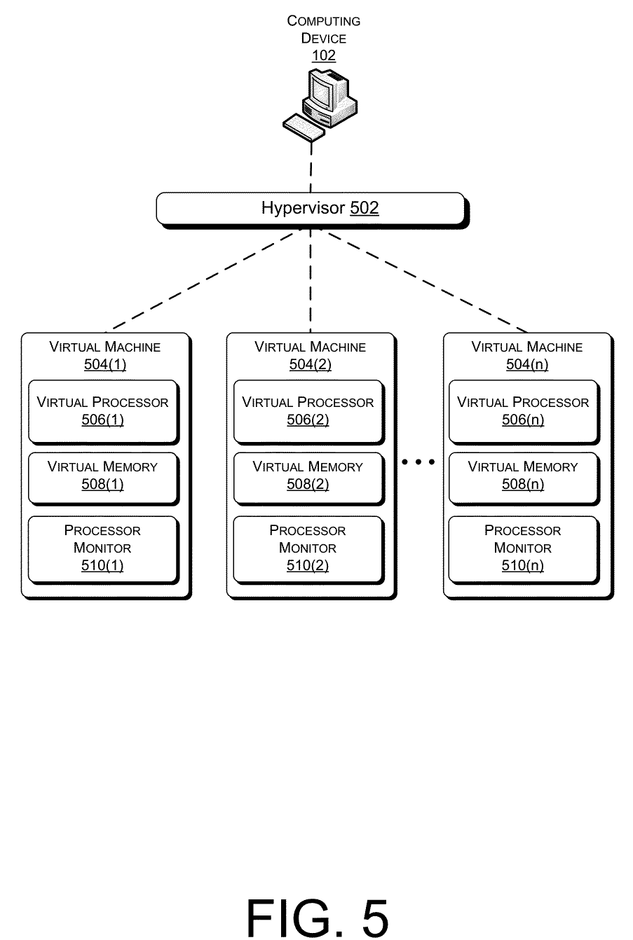

FIG. 5 is a block diagram of an illustrative system incorporating multiple virtual machines associated with a single computing device. In various embodiments, the techniques and systems described herein can be implemented across one or more virtual machines, for example in a cloud computing or distributed computing system. In some embodiments, within the memory of a computing device 102 (including PPM 120 and other modules and devices as described with reference to FIG. 1), a virtual machine manager (“VMM”) 502 (also called a hypervisor) can implement one or more virtual machines 504.

Virtual machines 504 can be configured to operate as stand-alone entities utilizing the hardware of computing device 504. The virtual machine 504 functions as a self-contained operating environment that acts as if it is a separate computer. In that regard, the virtual machine 504 includes a virtual processor 506 and a virtual memory 508 that enable the VM 504 to function as a separate computer distinct from computing device 102.

A VMM 502 can be installed on the server device to control and monitor execution of VMs 504. In various embodiments, VMM 502 may take on some or all of the functions otherwise described herein as being performed by PPM 120. In one implementation, VMM 502 executes directly on physical hardware of computing device 102, managing and allocating physical hardware in response to needs of VMs 504. In one implementation, hypervisor 502 may additionally virtualize one or more physical devices coupled to computing device 102

The virtual machine 504 in various embodiments also includes a processor monitor 510 for monitoring or sampling processor performance metrics relevant to virtual machine 504 and reporting the sampled metrics back to computing device 102. Sampled processor performance metrics can be, for example, any or all of the metrics of FIG. 3, any subset of those metrics, or performance metrics specific to virtual processors. In various embodiments, processor performance metrics of virtual machines 1 to n can be aggregated (for example, by PPM 120 or a separate processor monitor within hypervisor 502) for adjustment of a hardware processor associated with the virtual machines. The aggregation in various embodiments may take any one or several of various formats—for example, an average or median of any particular performance metrics can be used for adjusting a hardware processor. Other methods of aggregation are possible, and the method of aggregation can vary by the specific metric, type of virtual processor, type of hardware processor, user performance expectations, or other variables.

In other embodiments, adjustments according to the methods described herein can be made only for a specific virtual machine based on, for example, the workload or requirements of that virtual machine, its measured performance, and user expectations specific to that virtual machine.

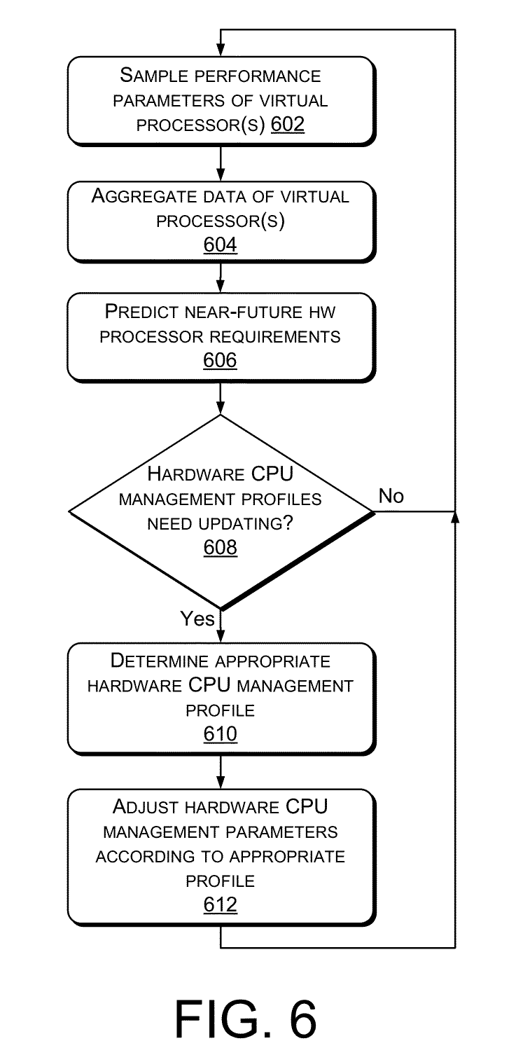

FIG. 6 is a flow chart of an example algorithm for adjusting hardware CPU management parameters in response to data sampled from one or more virtual machines associated with the hardware CPU, according to some embodiments. In various embodiments, the processes of FIG. 6 can be performed substantially by PPM 120 or by any combination of thread scheduler 114, analyzer module 116, forecast module 118, PPM 120, latency manager 126, VMM 502, virtual machine 504, processor monitor 510, virtual processor 506, and other tangible or abstract software or hardware modules or devices.

At step 602 in some embodiments, processor metrics can be sampled. In some embodiments, all or substantially all of the monitored processor performance metrics are the same as those monitored at step 202. In some embodiments, a separate sampling is not required at step 602, as the values sampled at step 202 of the CPU management parameter adjustment algorithm can also be used for the algorithm of FIG. 6 to adjust hardware CPU management parameters in response to data sampled from one or more virtual machines. In other embodiments, different or additional processor metrics can be monitored at step 602 and/or a separate polling of processor performance metrics can be performed at step 602. For example, additional processor performance metrics that are relevant to virtual processor can be monitored.

In various embodiments at step 604, data of various virtual processors can be aggregated. In various embodiments, processor performance metrics of virtual machines 1 to n can be aggregated for adjustment of a hardware processor associated with the virtual machines. As described elsewhere herein, aggregation may include averaging, finding median or mode, eliminating outlying data points, or other sampling and statistical analysis.

At step 606 of some embodiments, a prediction is generated of near-future requirements of a hardware processor associated with virtual machines. This prediction can be generated by, for example, PPM 120 or forecast module 118, based on, current or known future kernel threads and associated characteristics thereof; user device usage habit taking into account, for example: time of day and day of week, geographical location, or previous user behavior including applications and activities previously used simultaneously or in close time proximity with one another; or direct observation of current sample processor performance metrics including consideration of previously observed patterns in such metrics.

In some embodiments at step 608, PPM 120 compares sampled aggregated processor performance metrics against saved conditions for changing the processor management profile. Profile change conditions can be defined by a system designer or generated using observed system data. In some embodiments, profile change conditions can be adjusted using observed heuristic data. In some implementations, observed or heuristic data can include aggregation of system-wide events to infer changes in device or application operation, for example a user touching a device screen, browsing the web, or requesting playback of audio or video media.

At step 610 in some embodiments, having determined that a condition for profile change has been met, PPM 120 selects an appropriate management profile using the stored profile change conditions and sampled processor performance metrics. Where more than one profile change condition is set in some embodiments, profile change conditions can be ranked by priority. In other embodiments, PPM 120 can be configured such that various combinations of one or more profile change conditions can trigger a different processor management profile than would either of those conditions alone.

At step 612, PPM 120 applies the selected CPU management profile to a device's processor or processors. In some embodiments, changing the CPU management profile can be accomplished by accessing, for example, an Advanced Configuration and Power Interface (ACPI) of an operating system or by any other means of processor control provided by a processor manufacturer or a particular operating system of a device.

### Example Clauses

A. A method comprising monitoring one or more processor performance metrics of a processor of a computing device; predicting near-future processor performance requirements of the processor, the predicting based at least in part on the one or more processor performance metrics; selecting a CPU power management profile from a set of at least two stored CPU power management profiles, the selecting based at least in part on the predicted near-future processor performance requirements and user performance expectations; and applying the selected CPU power management profile to the processor.

B. A system comprising a processor; at least one virtual machine associated with the processor; a processor power management module configured to be operated by the processor to: monitor one or more processor performance metrics of the processor, monitor one or more processor performance metrics of the at least one virtual machine, aggregate the monitored processor performance metrics of the processor and the at least one virtual machine, predict near-future processor performance requirements of the processor, the predicting based at least in part on the one or more processor performance metrics, and adjust at least one CPU power management characteristic of the processor, the adjusting based at least in part on the predicted near-future processor performance requirements.

C. One or more computer-readable media having computer-executable instructions recorded thereon, the computer-executable instructions configured to cause the computing system to perform operations comprising: monitoring one or more processor performance metrics of a processor of a computing device; predicting near-future processor performance requirements of the processor, the predicting based at least in part on the one or more processor performance metrics; and adjusting at least one CPU power management characteristic of the processor, the adjusting based at least in part on the predicted near-future processor performance requirements.

D. The method as paragraph A recites, further comprising adjusting one or more of the stored CPU power management profiles in response to heuristic thread execution data.

E. The method as paragraph B or C recites, further comprising adjusting one or more of the stored CPU power management characteristics in response to heuristic thread execution data.

F. The method as paragraph D or E recites, the heuristic thread execution data comprising one or more of a change in number of device interrupts, a change in memory page faults, a change in a thread execution phase, or a detection of an event associated with high processing requirements.

G. The method as paragraph F recites, wherein the CPU power management profiles are initially generated at least in part based on the heuristic thread execution data.

H. The method as paragraph A recites, the selecting a CPU power management profile further based in part on a detected deficiency in performance of the device.

I. The method as paragraph B recites, the adjusting at least one CPU power management characteristic further based in part on a detected deficiency in performance of a computing device.

J. The method as paragraph C recites, the adjusting at least one CPU power management characteristic further based in part on a detected deficiency in performance of the computing device.

K. The method as paragraph A, B, or C recites, the one or more processor performance metrics further comprising one or more processor performance metrics of at least one virtual machine associated with the computing device.

L. The method as paragraph A, B, or C recites, wherein the processor is a virtual processor associated with a virtual machine.

M. The method as paragraph A recites, the monitored processor performance metrics comprising one or more of a thread priority, a thread execution time, a number of device interrupts, a number of memory page faults, or a number of input/output events.

N. The method as paragraph B or C recites, wherein the adjusting at least one CPU power management characteristic is based in part on user performance expectations.

O. The method as paragraph A or N recites, the user performance expectations based at least in part on a selected performance expectation tier.

P. The method as paragraph O recites, wherein the performance expectation tier is selected in response to at least one of a device type, a device mode, a thread priority, a user-specified priority of a thread, or a thread execution status.

Q. The method as paragraph A or N recites, the user performance expectations based at least in part on user behavior analysis.

R. The method as paragraph A or N recites, the user performance expectations based at least in part on predictions of future latency tolerances of one or more users of the device.

S. The method as paragraph A or N recites, the monitoring one or more processor performance metrics comprising sampling the processor performance metrics at regular sample intervals.

T. The system as paragraph B or K recites, further comprising a virtual machine manager for controlling the at least one virtual machine.

U. The system as paragraph B recites, the processor power management module further configured to adjust the at least one CPU power management characteristic by applying a CPU power management profile from a set of at least two CPU power management profiles.

V. The system as paragraph U recites, the processor power management module further configured to adjust the at least two CPU power management profiles in response to observed thread execution data.

W. The system as paragraph V recites, the processor power management module further configured to generate the set of at least two CPU power management profiles at least in part based on the observed thread execution data.

X. The computer-readable media as paragraph C recites, the computer-executable instructions further configured to update the user performance expectations based on observed user behavior.

### CONCLUSION

Although the techniques have been described in language specific to structural features and/or methodological acts, it is to be understood that the appended claims are not necessarily limited to the features or acts described. Rather, the features and acts are described as example implementations of such techniques.

Conditional language such as, among others, “can,” “could,” “might” or “may,” unless specifically stated otherwise, are understood within the context to present that certain embodiments include, while other embodiments do not include, certain features, elements and/or steps. Thus, such conditional language is not generally intended to imply that certain features, elements and/or steps are in any way required for one or more embodiments or that one or more embodiments necessarily include logic for deciding, with or without user input or prompting, whether certain features, elements and/or steps are included or are to be performed in any particular embodiment.

Conjunctive language such as the phrase “at least one of X, Y or Z,” unless specifically stated otherwise, is to be understood to present that an item, term, etc. can be either X, Y, or Z, or a combination thereof.

Any routine descriptions, elements or blocks in the flow charts described herein and/or depicted in the attached figures should be understood as potentially representing modules, segments, or portions of code that include one or more executable instructions for implementing specific logical functions or elements in the routine. Alternate implementations are included within the scope of the embodiments described herein in which elements or functions can be deleted, or executed out of order from that shown or discussed, including substantially synchronously or in reverse order, depending on the functionality involved as would be understood by those skilled in the art.

It should be emphasized that many variations and modifications can be made to the above-described embodiments, the elements of which are to be understood as being among other acceptable examples. All such modifications and variations are intended to be included herein within the scope of this disclosure and protected by the following claims.

What is claimed is:

1. A method comprising:
monitoring one or more processor performance metrics of a processor of a computing device;
predicting near-future processor performance requirements of the processor, the predicting based at least in part on the one or more processor performance metrics;
selecting a CPU power management profile from a set of at least two stored CPU power management profiles, the selecting based at least in part on the predicted near-future processor performance requirements and user performance expectations; and
applying the selected CPU power management profile to the processor.

2. The method of claim 1, further comprising adjusting one or more of the stored CPU power management profiles in response to heuristic thread execution data.

3. The method of claim 2, the heuristic thread execution data of the processor comprising one or more of a change in number of device interrupts, a change in memory page faults, a change in a thread execution phase, or a detection of an event associated with high or low processing requirements.

4. The method of claim 3, wherein the CPU power management profiles are initially generated at least in part based on the heuristic thread execution data.

5. The method of claim 1, the selecting a CPU power management profile further based in part on a detected deficiency in performance of the device.

6. The method of claim 1, the one or more processor performance metrics further comprising one or more processor performance metrics of at least one virtual machine associated with the computing device.

7. The method of claim 1, wherein the processor is a virtual processor associated with a virtual machine.

8. The method of claim 1, the monitored processor performance metrics comprising one or more of a thread priority, a thread execution time, a number of device interrupts, a number of memory page faults, or a number of input/output events.

9. The method of claim 1, the user expectations based at least in part on a selected performance expectation tier.

10. The method of claim 9, wherein the performance expectation tier is selected in response to at least one of a device type, a device mode, a thread priority, a user-specified priority of a thread, or a thread execution status.

11. The method of claim 1, the user expectations based at least in part on user behavior analysis.

12. The method of claim 1, the user expectations based at least in part on predictions of future latency tolerances of one or more users of the device.

13. The method of claim 1, the monitoring one or more processor performance metrics comprising sampling the processor performance metrics at regular sample intervals.

14. A system comprising:
a processor;
at least one virtual machine associated with the processor;
a processor power management module configured to be operated by the processor to:
monitor one or more processor performance metrics of the processor;
monitor one or more processor performance metrics of the at least one virtual machine;
aggregate the monitored processor performance metrics of the processor and the at least one virtual machine;
predict near-future processor performance requirements of the processor, the predicting based at least in part on the one or more processor performance metrics; and
adjust at least one CPU power management characteristic of the processor, the adjusting based at least in part on the predicted near-future processor performance requirements.

15. The system of claim 14 further comprising a virtual machine manager for controlling the at least one virtual machine.

16. The system of claim 14, the processor power management module further configured to adjust the at least one CPU power management characteristic by applying a CPU power management profile from a set of at least two CPU power management profiles.

17. The system of claim 16, the processor power management module further configured to adjust the at least two CPU power management profiles in response to observed thread execution data.

18. The system of claim 17, the processor power management module further configured to generate the set of at least two CPU power management profiles at least in part based on the observed thread execution data.

19. One or more computer-readable media having computer-executable instructions recorded thereon, the computer-executable instructions configured to cause the computing system to perform operations comprising:
monitoring one or more processor performance metrics of a processor of a computing device;
predicting near-future processor performance requirements of the processor, the predicting based at least in part on the one or more processor performance metrics; and
adjusting at least one CPU power management characteristic of the processor, the adjusting based at least in part on the predicted near-future processor performance requirements.

20. The computer-readable media of claim 19, the computer-executable instructions further configured to update the user performance expectations based on observed user behavior.
